(19) United States
(12) Patent Application Publication
(10) Pub. No.: US 2018/0128923 A1
(43) Pub. Date: May 10, 2018

(54) METHOD FOR REALIZING OR IMPROVING OBSTACLE AVOIDANCE FUNCTIONALITY OF FLYING DEVICE AND FLYING DEVICE USING THE SAME

(71) Applicant: HON HAI PRECISION INDUSTRY CO., LTD., New Taipei (TW)

(72) Inventor: MAO-KUO HSU, New Taipei (TW)

(21) Appl. No.: 15/681,244

(22) Filed: Aug. 18, 2017

(30) Foreign Application Priority Data
Nov. 9, 2016 (TW) 105136517

(51) Int. Cl. G01S 17/93; B64C 39/02

(52) U.S. Cl. CPC G01S 17/93; B64C 39/024; B64C 2201/141; B64C 2203/00; B64C 2201/146

(57) ABSTRACT

This disclosure relates to a method for realizing obstacle avoidance functionality of a flying device. The method includes: providing a flying device without obstacle avoidance functionality, wherein the flying device includes a flying body and a remote controller; the flying body includes a wireless receiving module, a flying controlling module and an actuator; and second, installing a sensor and a micro controlling module; the wireless receiving module only send a first flying order that is from the remote controller, to the micro controlling module; the sensor only send an obstacle information to the micro controlling module; and the micro controlling module calculates the first flying order and the obstacle information to obtain a second flying order, and sends the second flying order to the flying controlling module; and the flying controlling module controls the flying body to fly according to the second flying order.

### CROSS-REFERENCE TO RELATED APPLICATIONS

This application claims all benefits accruing under 35 U.S.C. § 119 from Taiwan Patent Application No. 105136517, filed on Nov. 9, 2016, in the Taiwan Intellectual Property Office, the contents of which are hereby incorporated by reference.

### BACKGROUND

### 1. Technical Field

The present disclosure relates to flying devices, especially, a method for realizing or improving obstacle avoidance of a flying device.

### 2. Description of Related Art

Remote control flying device are popular among youngsters. As science and technology continues to develop, the flying device becomes smaller in size and easier to operate. Some flying device can be operated even by children and could fly indoors. Collision with obstacle are bound to occur when the flying attitude is remotely controlled by users of different skills and experience, especially by children. Thus, safety of the flying device needs to be improved.

Currently, more and more flying devices include automatic obstacle avoidance functionality. Usually, the obstacle avoidance functionality is performed by a sensor and an obstacle avoidance module that is integrated with the flying controlling module. Since the program source code of the flying controlling module is not open by the coder, it is hard for users to realize or improve obstacle avoidance functionality of a flying device.

What is needed, therefore, is to provide a method for realizing or improving obstacle avoidance functionality of a flying device that can overcome the problems as discussed above.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary embodiments. Moreover, in the drawings, like reference numerals designate corresponding parts throughout the several views.

FIG. 1 is a functional diagram of a first exemplary embodiment of a flying device without obstacle avoidance functionality.

FIG. 2 is a functional diagram of the first exemplary embodiment of the flying device with obstacle avoidance functionality.

FIG. 3 is a flow chart of the first exemplary embodiment of a micro controlling module of the flying device with obstacle avoidance functionality.

FIG. 4 is a functional diagram of a second exemplary embodiment of a flying device with obstacle avoidance functionality.

FIG. 5 is a functional diagram of the second exemplary embodiment of the flying device with improved obstacle avoidance functionality.

FIG. 6 is a flow chart of the second exemplary embodiment of the micro controlling module of the flying device with improved obstacle avoidance functionality.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to considered as limiting the scope of the exemplary embodiments described herein.

Several definitions that apply throughout this disclosure will now be presented. The term “coupled” is defined as connected, whether directly or indirectly through intervening components, and is not necessarily limited to physical connections.

The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” exemplary embodiment in this disclosure are not necessarily to the same exemplary embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

References will now be made to the drawings to describe, in detail, various exemplary embodiments of the present method for realizing or improving obstacle avoidance functionality of a flying device.

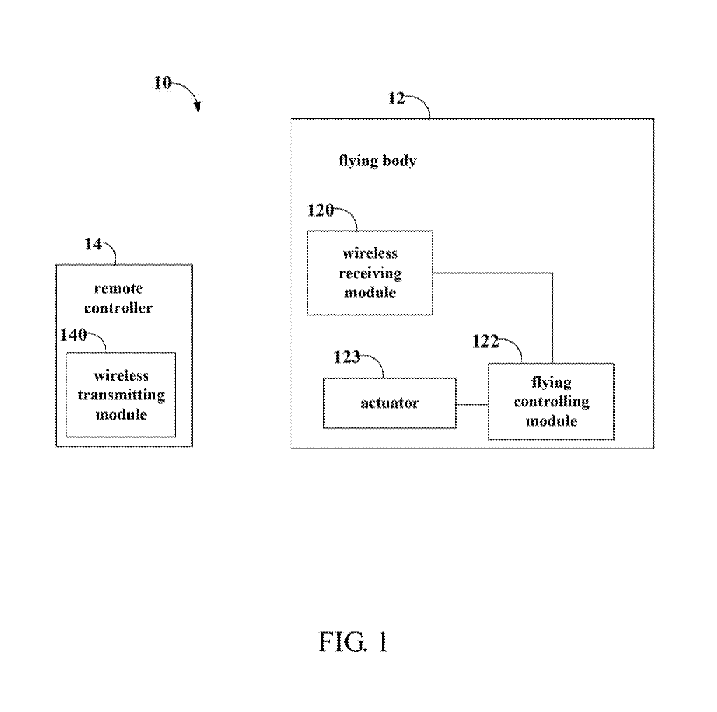

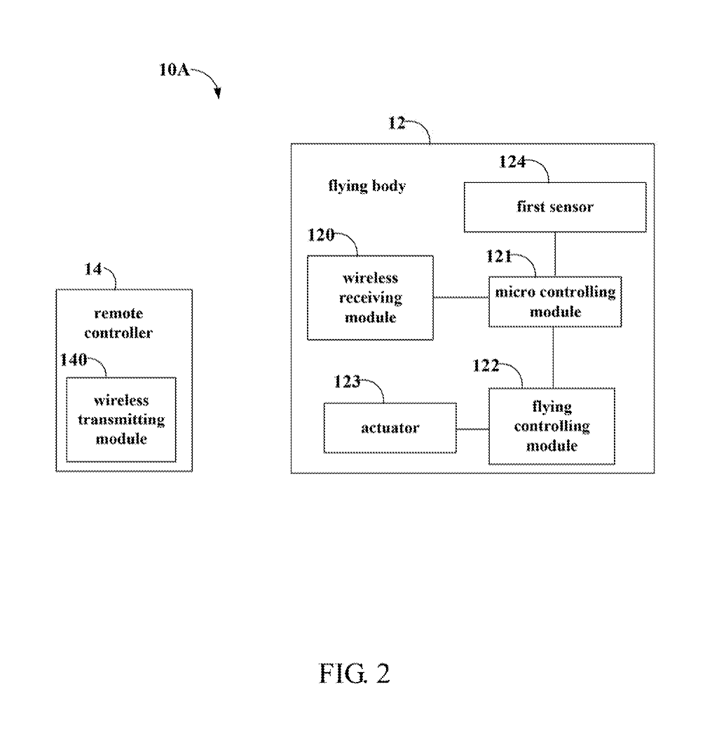

Referring to FIGS. 1-2, a method for realizing obstacle avoidance functionality of a flying device 10 without obstacle avoidance functionality of a first exemplary embodiment includes following steps:

In FIG. 1, step I provides a flying device 10 without obstacle avoidance functionality, where the flying device 10 includes a flying body 12 and a remote controller 14; the flying body 12 includes a wireless receiving module 120, a flying controlling module 122 electrically connected to the wireless receiving module 120, and an actuator 123 electrically connected to the flying controlling module 122; the wireless receiving module 120 receives a first flying order from the remote controller 14 and sends the first flying order to the flying controlling module 122; the flying controlling module 122 controls the flying body 12 to fly according to the first flying order; the remote controller 14 includes a wireless transmitting module 140; and

In FIG. 2, step II installs a first sensor 124 and a micro controlling module 121 electrically connected to the first sensor 124; where the wireless receiving module 120, the micro controlling module 121 and the flying controlling module 122 are electrically connected to each other in series; the wireless receiving module 120 receives a first flying order from the remote controller 14 and can only sends the first flying order to the micro controlling module 121; the first sensor 124 detects an obstacle information and can only sends the obstacle information to the micro controlling module 121; and the micro controlling module 121 calculates the first flying order and the obstacle information to obtain a second flying order and sends the second flying order to the flying controlling module 122; and the flying controlling module 122 controls the flying body 12 to fly according to the second flying order.

As shown in FIG. 2, a flying device 10A with obstacle avoidance functionality of the first exemplary embodiment is provided. The first sensor 124 can includes a radar ranging unit or ultrasonic ranging unit (not shown). The micro controlling module 121 can be a tiny computer including another processor different from the processor of the flying controlling module 122 and can be installed on the flying body 12 easily. The tiny computer can be a RASPBERRY PI® or BANANA PI®. In one exemplary embodiment, the micro controlling module 121 is a RASPBERRY PI® installed Linux system and acorn RISC machine (ARM) processor The RASPBERRY PI® looks like a credit card, but has an operational performance as strong as the intelligent mobile phone.

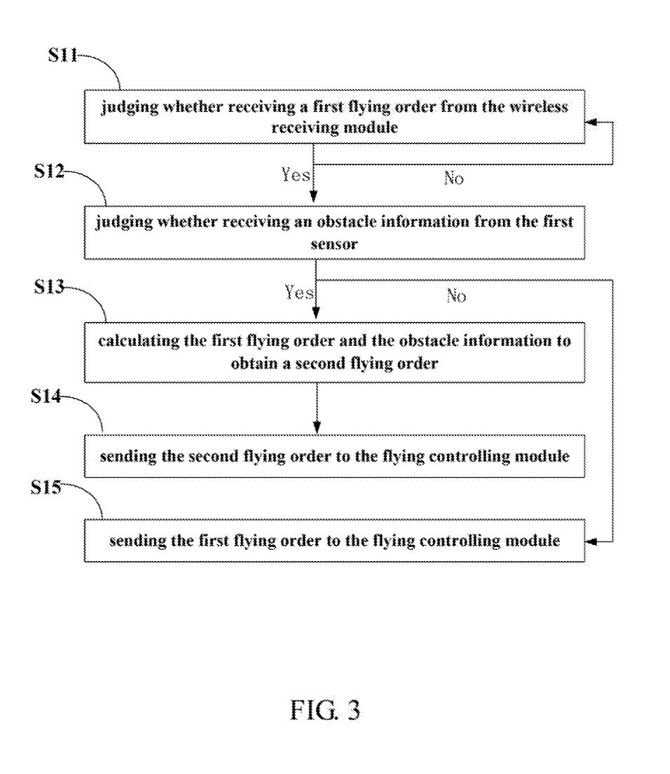

Referring to FIG. 3, a method of the first exemplary embodiment of the micro controlling module 121 of the flying device 10A with obstacle avoidance functionality includes following steps:

step (S11), determining whether the micro controlling module 121 receives a first flying order from the wireless receiving module 120 if yes, go to step (S12), if no, repeat step (S11);
step (S12), determining whether the micro controlling module 121 receives an obstacle information from the first sensor 124, if yes, go to step (S13), if no, go to step (S15);
step (S13), calculating the first flying order and the obstacle information to obtain a second flying order, go to step (S14);
step (S14), sending the second flying order to the flying controlling module 122; and
step (S15), sending the first flying order to the flying controlling module 122.

Step (S12), determining whether the micro controlling module 121 receives an obstacle information from the first sensor 124, includes only determining whether the micro controlling module 121 receives an obstacle information from the first sensor 124 after the micro controlling module 121 receives the last first flying order. The last first flying order is the first flying order received the last time by the micro controlling module 121.

Step (S13), calculating the first flying order and the obstacle information, includes only calculating the last first flying order and the obstacle information received after the last first flying order. Thus, the micro controlling module 121 requires less calculation time and has higher responsive speed.

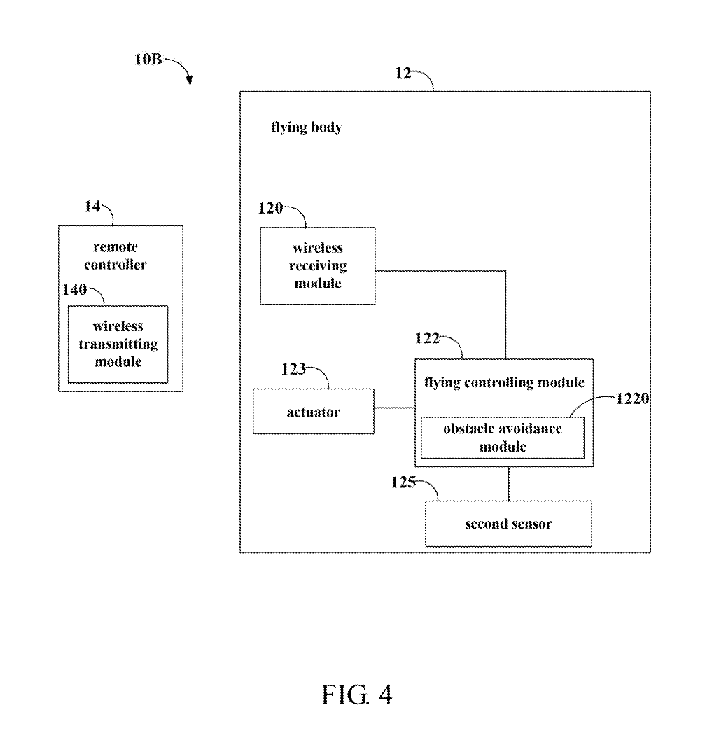

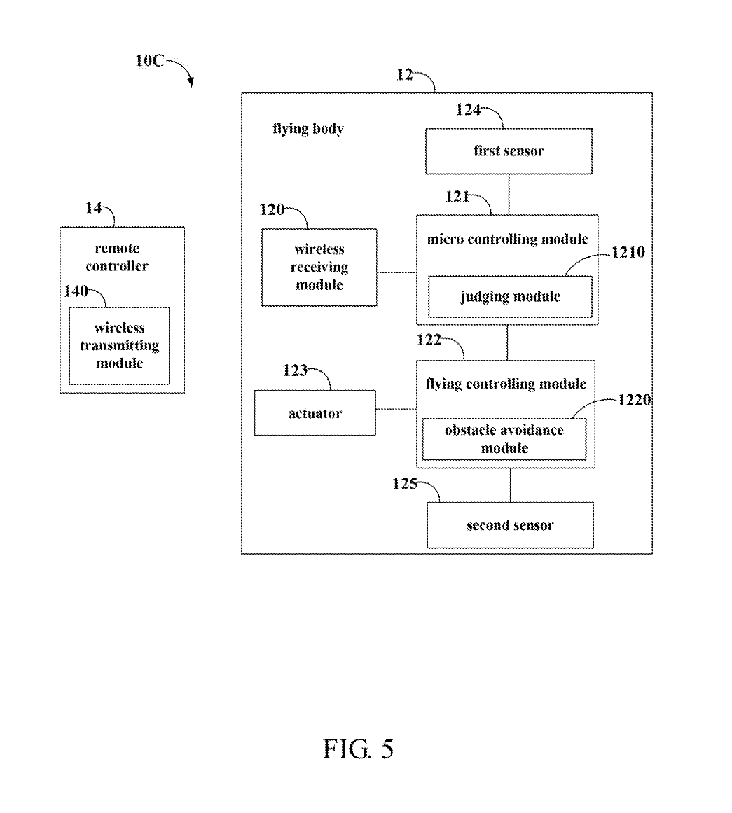

Referring to FIGS. 4-5, a method for improving obstacle avoidance functionality of a flying device 10B with obstacle avoidance functionality of a second exemplary embodiment includes following steps:

In FIG. 4, step I′ provides a flying device 10B with obstacle avoidance functionality, where the flying device 10B includes a flying body 12 and a remote controller 14; the flying body 12 includes a wireless receiving module 120, a flying controlling module 122 electrically connected to the wireless receiving module 120, an actuator 123 electrically connected to the flying controlling module 122, and a second sensor 125 electrically connected to the flying controlling module 122; the flying controlling module 122 includes an obstacle avoidance module 1220; the wireless receiving module 120 receives a first flying order from the remote controller 14 and sends the first flying order to the flying controlling module 122; the second sensor 125 detects a second obstacle information and sends the second obstacle information to the flying controlling module 122; the obstacle avoidance module 1220 calculates the first flying order and the second obstacle information to obtain a third flying order; the flying controlling module 122 controls the flying body 12 to fly according to the third flying order; the remote controller 14 includes a wireless transmitting module 140; and

In FIG. 5, step II′ installs a first sensor 124 and a micro controlling module 121 electrically connected to the first sensor 124; where the wireless receiving module 120, the micro controlling module 121 and the flying controlling module 122 are electrically connected to each other in series; the wireless receiving module 120 receives a first flying order from the remote controller 14 and can only sends the first flying order to the micro controlling module 121; the first sensor 124 detects a first obstacle information and can only sends the first obstacle information to the micro controlling module 121; the micro controlling module 121 calculates the first flying order and the first obstacle information to obtain a second flying order; where when the flying controlling module 122 does not receive the second obstacle information from the second sensor 125, the micro controlling module 121 sends the second flying order to the flying controlling module 122; when the flying controlling module 122 receives the second obstacle information from the second sensor 125, the micro controlling module 121 sends the first flying order to the flying controlling module 122, and the obstacle avoidance module 1220 calculates the first flying order and the second obstacle information to obtain a third flying order; and the flying controlling module 122 controls the flying body 12 to fly according to the second flying order or the third flying order.

As shown in FIG. 5, a flying device 10C with improved obstacle avoidance functionality of the second exemplary embodiment is provided. The flying device 10C with improved obstacle avoidance functionality includes two obstacle avoidance system and can realize the obstacle avoidance functionality even if one obstacle avoidance system does not work.

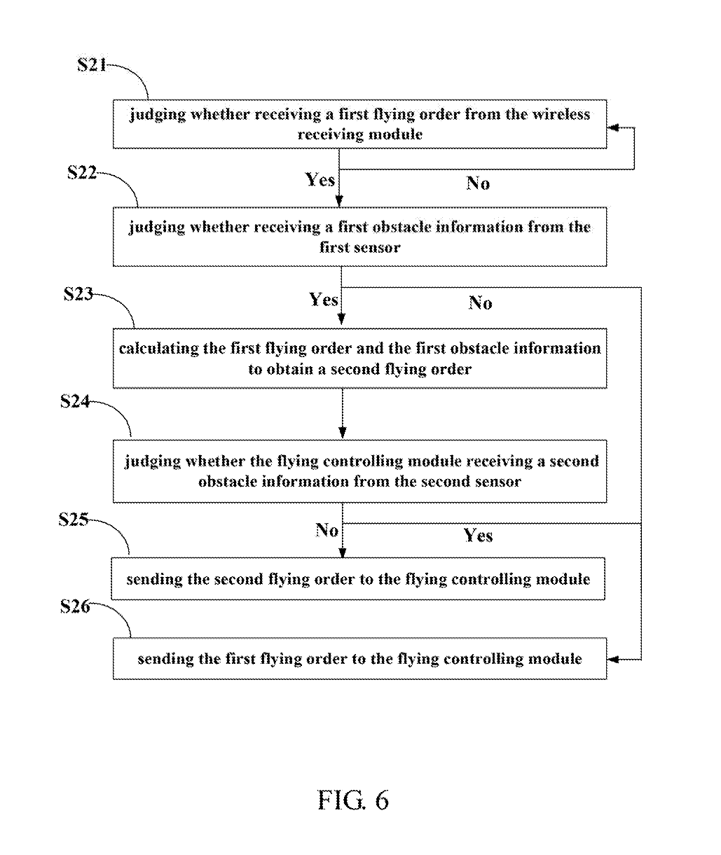

Referring to FIG. 6, a method of the second exemplary embodiment of the micro controlling module 121 of the flying device 10C with improved obstacle avoidance functionality includes following steps:

step (S21), determining whether the micro controlling module 121 receives a first flying order from the wireless receiving module 120, if yes, go to step (S22), if no, repeat step (S21);
step (S22), determining whether the micro controlling module 121 receives a first obstacle information from the first sensor 124, if yes, go to step (S23), if no, go to step (S26);
step (S23), calculating the first flying order and the first obstacle information to obtain a second flying order, go to step (S24);
step (S24), determining whether the flying controlling module 122 receives a second obstacle information from the second sensor 125, if yes, go to step (S26), if no, go to step (S25);
step (S25), sending the second flying order to the flying controlling module 122; and step (S26), sending the first flying order to the flying controlling module 122.

Step (S22), determining whether the micro controlling module 121 receives a first obstacle information from the first sensor 124, includes only determining whether the micro controlling module 121 receives a first obstacle information from the first sensor 124 after the micro controlling module 121 receives the last first flying order. The last first flying order is the first flying order received the last time by the micro controlling module 121.

Step (S23), calculating the first flying order and the first obstacle information, includes only calculating the last first flying order and the first obstacle information received after the last first flying order. Thus, the micro controlling module 121 takes less calculating time and have higher responsive speed.

Step (S24), determining whether the flying controlling module 122 receives a second obstacle information from the second sensor 125, includes only determining whether the flying controlling module 122 receives a second obstacle information from the second sensor 125 after the micro controlling module 121 sends one of a first flying order and a second flying order to the flying controlling module 122 last time.

The method for realizing or improving obstacle avoidance functionality of a flying device is simple and easy to achieve.

It is to be understood that the above-described exemplary embodiments are intended to illustrate rather than limit the disclosure. Any elements described in accordance with any exemplary embodiments is understood that they can be used in addition or substituted in other exemplary embodiments. Exemplary embodiments can also be used together. Variations may be made to the exemplary embodiments without departing from the spirit of the disclosure. The above-described exemplary embodiments illustrate the scope of the disclosure but do not restrict the scope of the disclosure.

Depending on the exemplary embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for realizing obstacle avoidance functionality of a flying device, the method comprising:
providing a flying device without obstacle avoidance functionality, wherein the flying device comprises a flying body and a remote controller; wherein the flying body comprises a wireless receiving module, a flying controlling module electrically connected to the wireless receiving module, and an actuator electrically connected to the flying controlling module; wherein the wireless receiving module receives a first flying order from the remote controller and sends the first flying order to the flying controlling module; wherein the flying controlling module controls the flying body to fly according to the first flying order; wherein the remote controller comprises a wireless transmitting module; and
installing a sensor and a micro controlling module electrically connected to the first sensor on the flying body; wherein the wireless receiving module, the micro controlling module and the flying controlling module are electrically connected to each other in series; wherein the wireless receiving module receives the first flying order from the remote controller and only sends the first flying order to the micro controlling module; wherein the sensor detects an obstacle information and only sends the obstacle information to the micro controlling module; wherein the micro controlling module calculates the first flying order and the obstacle information to obtain a second flying order and sends the second flying order to the flying controlling module; wherein the flying controlling module controls the flying body to fly according to the second flying order.

2. The method of claim 1, wherein a method of the micro controlling module comprises following steps.
step (S11), determining whether the micro controlling module receives a first flying order from the wireless receiving module, if yes, go to step (S12), if no, repeat step (S11);
step (S12), determining whether the micro controlling module receives an obstacle information from the first sensor, if yes, go to step (S13), if no, go to step (S15);
step (S13), calculating the first flying order and the obstacle information to obtain a second flying order, go to step (S14);
step (S14), sending the second flying order to the flying controlling module; and
step (S15), sending the first flying order to the flying controlling module.

3. The method of claim 2, wherein in determining whether the micro controlling module receives an obstacle information from the first sensor, only determining whether the micro controlling module receives an obstacle information from the first sensor after receiving a last first flying order, the last flying order is the first flying order received the last time by the micro controlling module.

4. The method of claim 3, wherein in calculating the first flying order and the obstacle information, only calculating the last first flying order and the obstacle information received after the last first flying order.

5. The method of claim 1, wherein the sensor comprises a radar ranging unit.

6. The method of claim 1, wherein the sensor comprises an ultrasonic ranging unit.

7. The method of claim 1, wherein the micro controlling module is a tiny computer.

8. A method for improving obstacle avoidance functionality of a flying device, the method comprising:
providing a flying device with obstacle avoidance functionality, wherein the flying device comprises a flying body and a remote controller; wherein the flying body comprises a wireless receiving module, a flying controlling module electrically connected to the wireless receiving module, an actuator electrically connected to the flying controlling module, and a second sensor electrically connected to the flying controlling module; wherein the flying controlling module comprises an obstacle avoidance module; wherein the wireless receiving module receives a first flying order from the remote controller and sends the first flying order to the flying controlling module; wherein the second sensor detects a second obstacle information and sends the second obstacle information to the flying controlling module; wherein the obstacle avoidance module calculates the first flying order and the second obstacle information to obtain a third flying order; wherein the flying controlling module controls the flying body to fly according to the third flying order; wherein the remote controller comprises a wireless transmitting module; and
installing a first sensor and a micro controlling module electrically connected to the first sensor on the flying body; wherein the wireless receiving module, the micro controlling module and the flying controlling module are electrically connected to each other in series; wherein the wireless receiving module receives the first flying order from the remote controller and only sends the first flying order to the micro controlling module; wherein the first sensor detects a first obstacle information and only sends the first obstacle information to the micro controlling module; wherein the micro controlling module calculates the first flying order and the first obstacle information to obtain a second flying order;
wherein when the flying controlling module does not receive the second obstacle information from the second sensor, the micro controlling module sends the second flying order to the flying controlling module; when the flying controlling module receives the second obstacle information from the second sensor, the micro controlling module sends the first flying order to the flying controlling module, and the obstacle avoidance module calculate the first flying order and the second obstacle information to obtain the third flying order; wherein the flying controlling module controls the flying body to fly according to the second flying order or the third flying order.

9. The method of claim 8, wherein a method of the micro controlling module comprises following steps.
step (S21), determining whether the micro controlling module receives a first flying order from the wireless receiving module, if yes, go to step (S22), if no, repeat step (S21);
step (S22), determining whether the micro controlling module receives a first obstacle information from the first sensor, if yes, go to step (S23), if no, go to step (S26);
step (S23), calculating the first flying order and the first obstacle information to obtain a second flying order, go to step (S24);
step (S24), determining whether the flying controlling module receives a second obstacle information from the second sensor, if yes, go to step (S26), if no, go to step (S25);
step (S25), sending the second flying order to the flying controlling module; and
step (S26), sending the first flying order to the flying controlling module.

10. The method of claim 9, wherein in determining whether the micro controlling module receives a first obstacle information from the first sensor, only determining whether the micro controlling module receives the first obstacle information from the first sensor after receiving a last first flying order which is the first flying order received the last time by the micro controlling module.

11. The method of claim 10, wherein in calculating the first flying order and the first obstacle information, only calculating the last first flying order and the first obstacle information received after the last first flying order.

12. The method of claim 11, wherein in determining whether the flying controlling module receives a second obstacle information from the second sensor, only determining whether the flying controlling module receives the second obstacle information from the second sensor after the micro controlling module sends one of the first flying order and the second flying order to the flying controlling module last time.

13. The method of claim 8, wherein the first sensor or the second sensor comprises a radar ranging unit.

14. The method of claim 8, wherein the first sensor or the second sensor comprises an ultrasonic ranging unit.

15. The method of claim 8, wherein the micro controlling module is a tiny computer.

16. A flying device, comprising: a flying body and a remote controller; wherein the remote controller comprises: a wireless transmitting module; wherein the flying body comprises: a wireless receiving module, a first sensor, a micro controlling module electrically connected to the wireless receiving module and the first sensor, a flying controlling module electrically connected to the micro controlling module, an actuator electrically connected to the flying controlling module, and a second sensor electrically connected to the flying controlling module; wherein the flying controlling module comprises an obstacle avoidance module;
wherein the wireless receiving module, the micro controlling module and the flying controlling module are electrically connected to each other in series; wherein the wireless receiving module receives a first flying order from the remote controller and only sends the first flying order to the micro controlling module; wherein the first sensor detects a first obstacle information and only sends the first obstacle information to the micro controlling module; wherein the micro controlling module calculates the first flying order and the first obstacle information to obtain a second flying order; wherein the second sensor detects a second obstacle information and sends the second obstacle information to the flying controlling module;
wherein when the flying controlling module does not receive the second obstacle information from the second sensor, the micro controlling module sends the second flying order to the flying controlling module; when the flying controlling module receives the second obstacle information from the second sensor, the micro controlling module sends the first flying order to the flying controlling module, and the obstacle avoidance module calculate the first flying order and the second obstacle information to obtain a third flying order; wherein the flying controlling module controls the flying body to fly according to the second flying order or the third flying order.

17. The flying device of claim 16, wherein a method of the micro controlling module comprises following steps.
step (S21), determining whether the micro controlling module receives a first flying order from the wireless receiving module, if yes, go to step (S22), if no, repeat step (S21);
step (S22), determining whether the micro controlling module receives a first obstacle information from the first sensor, if yes, go to step (S23), if no, go to step (S26);
step (S23), calculating the first flying order and the first obstacle information to obtain a second flying order, go to step (S24);
step (S24), determining whether the flying controlling module receives a second obstacle information from the second sensor, if yes, go to step (S26), if no, go to step (S25);
step (S25), sending the second flying order to the flying controlling module; and
step (S26), sending the first flying order to the flying controlling module.

18. The flying device of claim 17, wherein in determining whether the micro controlling module receives a first obstacle information from the first sensor, only determining whether the micro controlling module receives the first obstacle information from the first sensor after receiving a last first flying order which is the first flying order received the last time by the micro controlling module.

19. The flying device of claim 18, wherein in calculating the first flying order and the first obstacle information, only calculating the last first flying order and the first obstacle information received after the last first flying order.

20. The flying device of claim 19, wherein in determining whether the flying controlling module receives a second obstacle information from the second sensor, only determining whether the flying controlling module receives the second obstacle information from the second sensor after the micro controlling module sends one of the first flying order and the second flying order to the flying controlling module last time.
